(19) United States
(12) Patent Application Publication
(10) Pub. No.: US 2004/0037463 A1
(43) Pub. Date: Feb. 26, 2004

(54) Recognizing multi-stroke symbols

(76) Inventors: Christopher L. Calhoun, Mountain View, CA (US); Thomas F. Stahovich, Mars, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/350,952

(22) Filed: Jan. 24, 2003

Related U.S. Application Data
(60) Provisional application No. 60/352,325, filed on Jan. 28, 2002.

(51) Int. Cl. G06K 9/18; G06K 9/46

(52) U.S. Cl. 382/186; 382/202

(57) ABSTRACT

We disclose a trainable recognizer for multi-stroke symbols. Pen speed and the curvature are examined to segment a stroke into the constituent primitives. The primitives are determined to be lines or arcs using, for example, a least squares best fit method. Symbol recognition (training) results in the construction of definitions consisting of the constituent geometric primitives (lines and arcs), the properties of individual primitives, and the geometric relationships between them. A definition is learned by examining a few examples of a symbol and identifying which properties and relationships occur frequently. Thereafter, during symbol recognition (matching), an unknown symbol is identified by determining which definition matches the unknown with the least error. We disclose two recognition methods. One assumes that the primitives of a symbol are always drawn in the same order. This method is fast, but requires some care from the drawer. The other method uses a form of best-first search, with a speculative quality metric and pruning, to recognize symbols when the drawing order is varied. During both training and recognition, multiple primitives can be drawn in the same pen stroke.

This application claims the benefit under 35 U.S.C. §119(e) of the co-pending provisional application Serial No.60/352,325 entitled Recognizing Multi-Stroke Symbols filed on Jan. 28, 2002, which is incorporated herein by reference.

### BACKGROUND OF THE INVENTION

The present invention is directed generally to machine learning techniques and, more particularly, to machine learning techniques for recognizing sketched symbols and shapes for use in a sketch based user interface.

There are a number of processes underlying a sketch-based user interface. These include the low level processing of pen strokes, recognition of symbols, reasoning about shapes, and high-level interpretation.

The problem of polygon fitting and corner point (segment point) detection from digital curves has attracted numerous researchers: Witkin, A. P. 1984. Scale space filtering: A new approach to multi-scale description. Image Understanding 79-95; Rattarangsi, A., and Chin, R. T. 1992. Scale-based detection of corners of planar curves. IEEE Transactions on Pattern Analysis and Machine Intelligence 14(4):430-339; Bentsson, A., and Eklundh, J. 1992. Shape representation by multiscale contour approximation. IEEE PAMI 13, p. 85-93; Dudek, G., and Tsotsos, J. 1997. Shape representation and recognition from multiscale curvature. CVIU 68(2): 170-189. For corner identification, most algorithms search for abrupt changes in direction by maximizing the curvature function. To suppress noise and false corners, the input data is usually smoothed with a filter. The main challenge here is to determine a reliable “observation scale” or amount of smoothing. Single-scale representations often lead to non-optimal results. Too little smoothing leads to superfluous corners whereas excessive smoothing causes the disappearance of true corners.

Witkin 1984 and Rattarangsi & Chin 1992 describe methods based on a multiple-scale representation in which different levels of smoothing can be used for different regions along a curve. Corners are detected by monitoring points that maintain high values of curvature as the amount of smoothing is successively increased. These approaches are computationally intensive and thus may not be suitable for interactive sketching systems. Furthermore, these methods consider only the shape of a curve; additional information may need to be considered to help determine which discontinuities were intended.

Igarashi, T.; Matsuoka, S.; Kawachiya, S.; and Tanaka, H. 1997. Interactive beautification: A technique for rapid geometric design. In UIST '97, 105-114, created an interactive beautification system. Their task is to transform the user's pen strokes into cleaned-up line segments and infer any intended connected-ness, perpendicularity, congruence, and symmetry. The resulting image resembles a carefully drafted diagram despite the imprecision associated with the user's original sketch. They consider only lines (no arcs) and they require each line to be drawn with a separate pen stroke.

Rubine, D. 199 1, Specifying gestures by example, Computer Graphics 25:329-33, describes a trainable, single-stroke gesture recognizer for click and drag interfaces. A stroke is characterized by a set of 11 geometric and 2 dynamic attributes. A class of gestures is defined by a linear function of these 13 attributes. Training is accomplished by learning appropriate weights for each attributes in the linear function. The attributes consider aggregate properties of a pen stroke, and it is possible that two different gestures would have the same aggregate properties.

Fonseca, M. J., and Jorge, J. A. 2000, Using Fuzzy Logic to Recognize Geometric Shapes Interactively, In Proceedings of the 9th Int. Conference on Fuzzy Systems (FUZZ-IEEE 2000), describe a method, based on fuzzy logic, for recognizing both multi-stroke and single-stroke shapes. Each shape is characterized by a number of geometric features calculated from three special polygons: 1) the smallest convex hull that can be circumscribed around the shape, 2) the largest triangle that can be inscribed in the hull, and 3) the largest quadrilateral that can be inscribed. Using the areas and perimeters of these polygons, a number of features such as thinness, hollowness and openness are computed. The system is manually trained by identifying the right fuzzy feature sets to characterize a shape and distinguish it from the other shapes. An unknown scribble is recognized by computing its degree of membership in the fuzzy set definitions of the various known shapes. Because the method relies on aggregate features of the pen strokes, it might be difficult to differentiate between similar shapes. Also, the method is unable to identify the constituent parts of a shape.

Landay, J. A., and Myers, B. A. 2001, Sketching interfaces: Toward more human interface design, IEEE Computer 34(3):56-64, presents an interactive sketching tool called SILK that allows designers to quickly sketch out a user interface and transform it into a filly operational system. As the designer sketches, SILK's recognizer, which is adapted from Rubine 1991, supra, matches the pen strokes to symbols representing various user interface components, and returns the most likely interpretation. Their recognizer is limited to single-stroke shapes drawn in certain preferred orientations.

Cohen, F.; Huang, Z.; and Yang, Z. 1995, Invariant matching and identification of curves using b-splines curve representation, IEEE Transactions on Image Processing. 4(I): 1-10 and Huang, Z., and Cohen, F. 1996, Affine-invariant b-spline moments for curve matching. IEEE Transactions on Image Processing. 5(10): 1473-1480, describe a method for matching and classifying curves using B-splines, invariant to affine transformations. This method is particularly suitable for identifying single-stroke sketches such as characters in handwritten text or gestural commands. A reported application involves matching handwritten text to a likely writer for criminal investigations. A benefit of this approach is that there is no need to segment the pen stroke. However, many of the symbols of interest to us cannot be drawn as single strokes.

Gross' Electronic Cocktail Napkin (Gross, M., and Do, E. 1996, Ambiguous intentions: a paper-like interface for creative design, In Proceedings of UIST96, 183-192) employs a trainable recognizer that works for multi-stroke shapes. The recognition process is decomposed into glyph (low-level) and configuration (high-level) recognition. A glyph is described by a state transition model of the pen path, the aspect ratio and size of the bounding box, and the number of corner points. The pen path is described as a sequence of state transitions, where a state is one of the 9 regions obtained by dividing the bounding box into a 3×3 grid. Corners are identified when the change in drawing direction exceeds 45 degrees. Configuration recognition considers the spatial relationships between the glyphs. This method is sensitive to changes in orientation and the 3x3 grid may be inadequate for symbols containing small features.

Stahovich et al. (Stahovich, T. F.; Davis, R.; and Shrobe, H. 1998, Generating multiple new designs from a sketch, Artificial Intelligence 104(1-2):21 1-264 and Stahovich, T. F. 1996, SketchIT: a sketch interpretation tool for conceptual mechanical design, Technical report 1573, MIT AI Laboratory) have developed a program called SketchIT that can transform a sketch of a mechanical device into working designs. The program employs a novel behavioral representation called qualitative configuration space (qc-space), that captures the behavior suggested by a sketch while abstracting away the particular geometry used to suggest that behavior. Qc-space allows SketchIT to identify the geometric constraints that must be satisfied for the device to work as desired. The desired behavior is specified by the user via a state transition diagram. Once the program has identified the constraints, it uses them to synthesize new working designs. Each new design is represented as a behavior ensuring parametric model (“BEP-Model”): a parametric model augmented with constraints that ensure the overall device geometry behaves as intended. The constraints of the BEP-Model actually define a family of geometries that all produce the same set of behaviors. SketchIT is concerned only with the high-level processing of the sketch; it assumes that the lines and arcs contained in the sketch are extracted by another program.

Mankoff, J.; Abowd, G. D.; and Hudson, S. E. 2000, Oops: a toolkit supporting mediation techniques for resolving ambiguity in recognition-based interfaces, Computers and Graphics 24(6).-819-834 have explored methods for modeling and resolving ambiguity in recognition-based interfaces. Drawn from a survey on existing recognizers, they present a set of ambiguity resolution strategies, called mediation techniques, and demonstrate their ideas in a program called Burlap. Their resolution strategies are concerned with how ambiguity should be presented to the user and how the user should indicate his or her intention to the software.

### BRIEF SUMMARY OF THE INVENTION

The present invention is directed to a method, and software for implementing the method, of analyzing a symbol comprised of one or more drawn strokes. The method is comprised of calculating the speed of drawing along each stroke. A curvature metric is calculated along each stroke. Using the calculated speed and the curvature, segment points within each stroke are identified. Each segment between segment points is then classified as a type of primitive. A semantic network description is constructed of the unknown symbol using the primitives and relationships between the primitives. Thereafter, the description of the unknown symbol may be used in conjunction with the plurality of stored definitions of known symbols to enable (e.g. by matching) selection of one of the known symbols as corresponding to the unknown symbol.

We have developed sketch understanding techniques that enable sketched-based user interfaces. That enables people to operate software by drawing the kinds of sketches they ordinarily draw. For example, an engineer would be able to create a dynamic simulation of a mechanism by sketching a simple schematic of it, using familiar symbols and drawing conventions. Similarly, a user would be able to create vu-graphs by sketching the desired graphics, such as arrows, boxes, quote bubbles, etc.

We have developed techniques for segmenting pen strokes into their constituent lines and arcs. We have also developed a trainable symbol recognizer that learns to recognize a symbol by examining a few examples of it.

Our recognizer operates on the output of the stroke segmenter. This provides for a more natural drawing environment by allowing the user to vary the number of pen strokes used to create a symbol. For example, a square can be drawn as a single pen stroke, or as four separate strokes, or even as two or three strokes. Much of the previous work has relied either on single stroke methods in which an entire symbol must be drawn as single stroke (e.g., Rubine 1991, supra, Kimura, T. D.; Apte, A.; and Sengupta, S. 1994, A graphic diagram editor for pen computers, Software Concepts and Tools 82-95; Cohen, Huang, & Yang 1995, supra,) or single primitive methods in which each stroke must be a single line, arc, or curve (e.g., Zhao, R. 1993, Incremental recognition in gesture-based and syntax directed diagram editor, In Proceedings of InterCHI'93, 95-1 00; Igarashi et al. 1997, supra; Weisman, L. 1999, A foundation for intelligent multimodal drawing and sketching programs, Master's thesis, MIT ).

One of the challenges in segmenting is determining which bumps and bends in a pen stroke are intended and which are accidents. Our approach to segmenting considers both the shape of the stroke and the motion of the pen tip as the stroke is created. We have found that it is natural to significantly slow the pen when making intentional discontinuities in the pen stroke. We can identify such discontinuities by examining the speed profile of the pen stroke. The speed-based approach finds many segment points, but not all. We use a smoothed curvature metric to identify those sorts of segment points.

Our symbol recognizer employs an approach similar to near miss learning. To train the recognizer, the user provides several examples of a symbol. The strokes are segmented and each example is characterized by a semantic network description. The semantic networks are compared, and any sketch properties (network links) that occur frequently are assembled to form a definition of the symbol. We have found that three or four training examples are often adequate for learning engineering symbols such as pivots, beams, springs, and pulleys of the type shown in FIG. 1. To recognize an unknown symbol, the strokes are segmented and a semantic network is constructed. The network is matched against each known definition, and an error is calculated describing the difference between the symbol and that definition. The symbol is identified by the definition that fits with the least error.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 illustrates typical symbols; basic shapes include a line, arc, triangle, square, and pie slice; mechanical objects include a pulley and ropes, pivot, spring and beam;

FIG. 2(a) illustrates a raw pen stroke, FIG. 2(b) an interpretation as a single line and FIG. 2(c) an interpretation as three lines;

FIG. 3(a) illustrates a raw pen stroke, FIG. 3(b) an interpretation as two lines and FIG. 3(c) an interpretation as an arc;

FIG. 4 illustrates a square drawn using a stylus and the associated pen tip speed profile; the corners are identifiable by the low speed;

FIG. 5 illustrates the segment points for thresholds of (a) 20% (b) 25% and (c) 35% of the average pen speed;

FIG. 6 illustrates the calculation of the curvature sign using a window having nine points;

FIG. 7 illustrates the segment points for curvature window sizes of (a) 30 (b) 15 and (c) 10 points (Note that speed segment points are not shown);

FIG. 8 illustrates the saturating error function for continuous valued properties; and

FIG. 9 illustrates exemplary hardware on which the present invention may be practiced.

### DETAILED DESCRIPTION OF THE INVENTION

Pen Stroke Segmenting

The first step in interpreting a sketch is processing the individual pen strokes to determine what shapes they represent. Much of the previous work in this area assumes that each pen stroke represents a single shape, such as a single line segment or arc segment, which ever fits the stroke best. While this kind of approach facilitates shape recognition, it results in a less than natural user interface. For example, one would be forced to draw a square as four individual pen strokes, rather than a single pen stroke with three 90° bends.

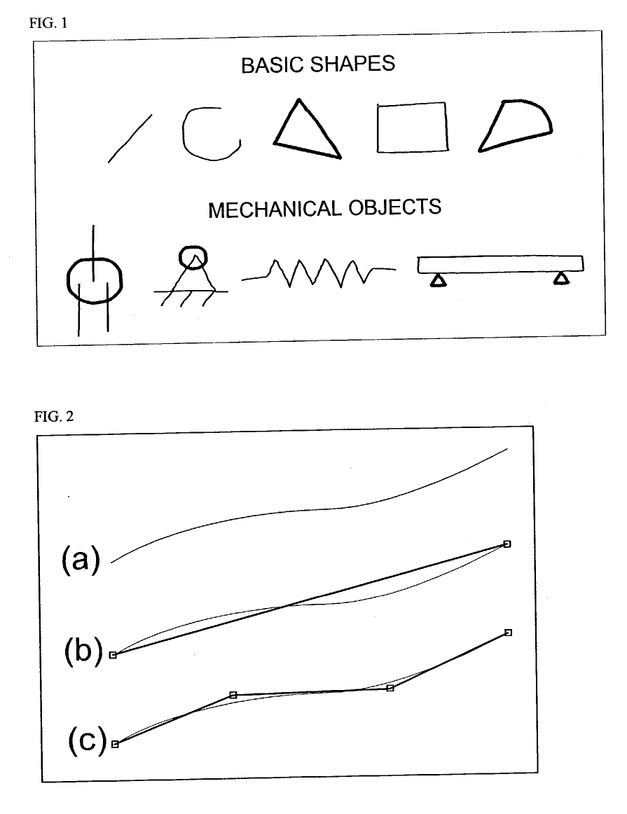

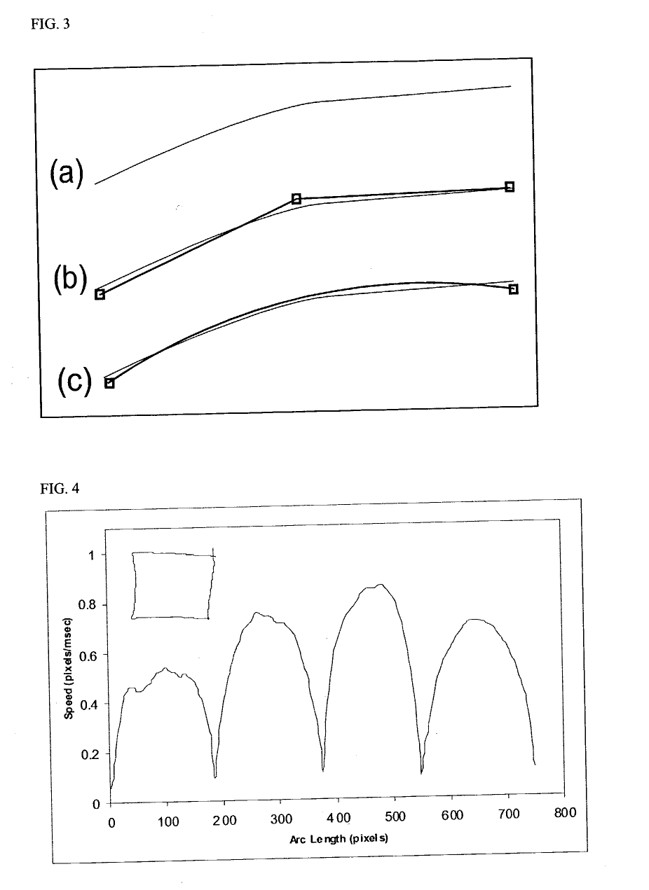

Our invention facilitates a natural sketch interface by allowing pen strokes to represent any number of shape primitives connected together. This requires examining each stroke to identify the segment points, the points that divide the stroke into different primitives. The key challenge is determining which bumps and bends are intended and which are accidents. Consider, the pen stroke in FIG. 2(a), for example. Was this intended to be a single straight line as in FIG. 2(b), or three straight lines as in FIG. 2(c)? Similarly, was the pen stroke in FIG. 3(a) intended to be two straight lines forming a corner as in FIG. 3(b), or was it intended to be a segment of an arc as in FIG. 3(c)? We have found it difficult to answer these sorts of question by considering shape alone. The size of the deviation from an ideal line or arc is not a reliable indicator of what was intended: sometimes small deviations are intended while other times large ones are accidents.

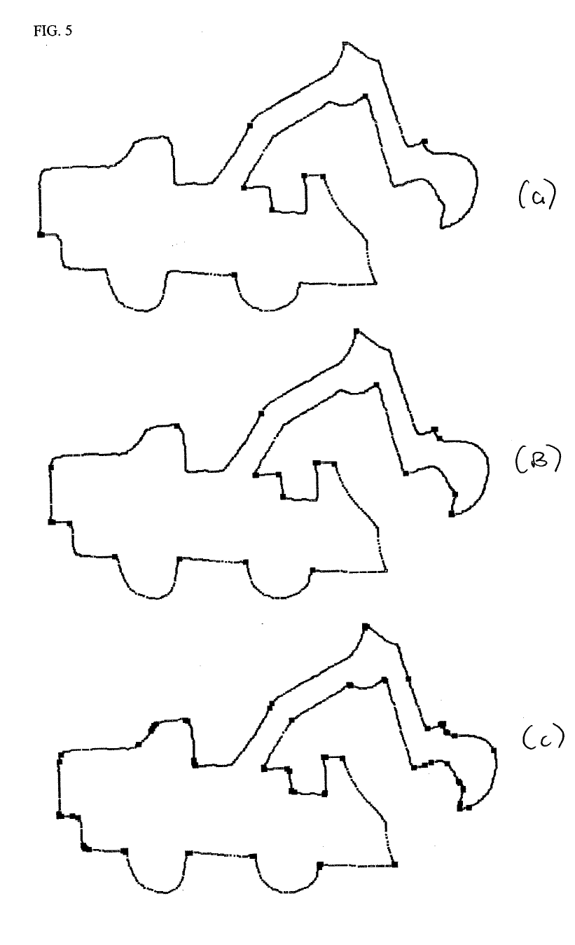

Our approach to this problem relies on examining the motion of the pen tip as the strokes are created. We have discovered that it is natural to slow the pen when making many kinds of intentional discontinuities in the shape. For example, if the stroke in FIG. 3(a) was intended to be two lines forming a corner, the drawer would likely have slowed down when making the corner. Similarly, when drawing a rectangle as a single pen stroke, it is natural to slow down at the corners, which are the three segment points. FIG. 4 shows the speed profile for a typical square. The corners can be easily identified by the low pen speed.

Pen speed can be calculated in a number of ways. In our method, pen speed is calculated as the distance traveled between consecutive pen samples divided by the time elapsed between the samples. Distance is measured in the hardware coordinates of the input device. Because most pen input devices emulate a mouse, we have written our software to use a standard mouse programming interface. (We have written another version of our software that uses the standard programming interface for standard digitizing pad and stylus systems.) This has allowed us to use our software with an electronic white-board, a stylus and digitizing pad, and a conventional mouse. We initially used an event-driven software model, but found that the temporal resolution was inadequate on some platforms. Our current approach is to use the event-driven model to handle pen up and pen down events, and to poll for the mouse position in between. This has allowed us to increase the resolution, but it does result in redundant samples when the mouse is stationary. When the mouse is stationary, there is a sequence of samples that all have zero velocity. We discard all but the first sample in these sequences.

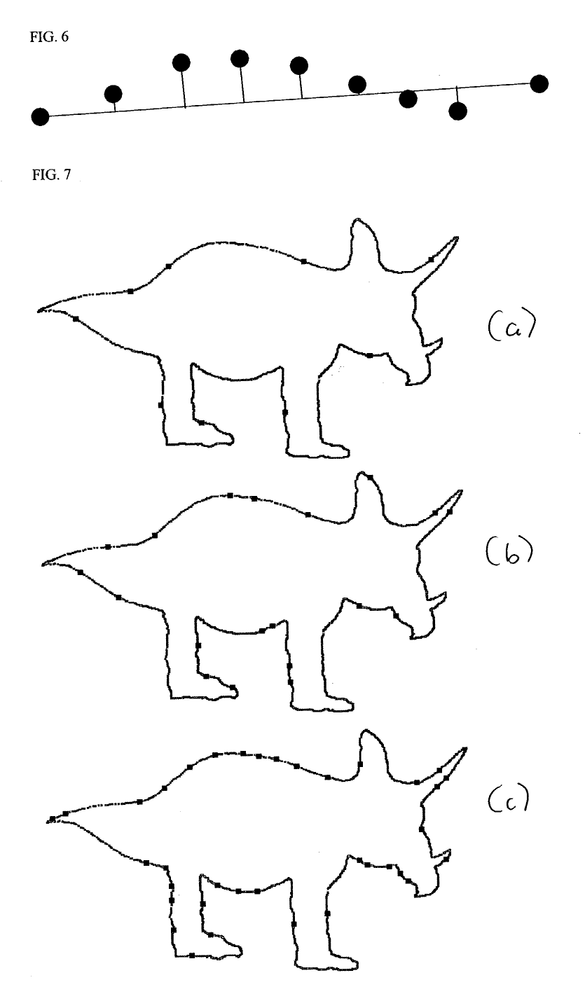

Once the pen speed has been calculated at each point along the stroke, segment points can be found by thresholding the speed. Any point that is a local speed minimum, and has a speed below the threshold is a segment point. We specify the threshold as fraction of the average speed along the particular pen stroke. If necessary, the user can adjust the threshold to match his or her particular drawing style. In our informal testing, we have found that with a small amount of tuning, one can achieve good results. FIG. 5 shows the segment points that are detected for a typical pen stroke for various values of a fixed threshold. To enhance the performance of this approach, one can slightly exaggerate the slowdown at intended segments points. The drawing experience is still natural because no pen up and pen down events are necessary, and there is no need to stop completely.

While many intentional discontinuities occur at low pen speed, others do not. For example, when drawing an “S” shape, there may not be a reduction in pen speed at the transition from one lobe to the other. We can locate these kinds of segment points by examining the curvature of the pen stroke. Segment points occur at locations where the curvature changes sign. We consider three distinct signs: positive, negative, and zero. When computing the sign, we examine a window of points on either side of the point in question. We connect the first and last points in the window with a line segment. We then calculate the minimum distance from each point in the window to the line. Distances to the left of the line are positive, while those to the right are negative. Left and right are defined relative to the drawing direction. The signed distances are summed to determine the sign of the curvature. If the absolute value of the sum is less than a threshold, the curvature is considered to be zero. In the example in FIG. 6, the curvature is positive because there are more positive distances than negative ones. (In this example, the drawing direction is from left to right.)

By using a window of points to compute the sign of the curvature, we are able to smooth out noise in the pen signal. Some of the noise comes from minor fluctuations in the drawing, other noise comes from the digitizing error of the input device. The larger the window, the larger the smoothing effect. The size of the window must be tuned to the input device and the user. For mouse input, we have found a window size of between 10 and 30 points to be suitable. FIG. 7 shows how the number of segment points varies with the window size.

Once the strokes have been segmented, the next task is to determine which segments represent lines and which represent circular arcs or other types of geometric primitives. We compute the least squares best fit line and arc for each segment. The segment is typically classified by the shape that matches with the least error. However, nearly straight lines can always be fit with high accuracy by an arc with a very large radius. In such cases, we use a threshold to determine if a segment should be an arc or a line. To be an arc, the arc length must be at least 15°. Other techniques and thresholds may be used.

Symbol Recognition: Training (Learning and Storing Definitions)

After segmenting the pen strokes, the next step is to recognize individual symbols. We have developed a trainable symbol recognizer for this purpose. Our approach is similar to near miss learning, except that currently we consider only positive training examples. To train the system, the user provides several examples of a given symbol. Each example is characterized by a semantic network description. The networks for the various examples are compared, and any sketch properties (network links) that occur frequently are assembled to form a definition of the symbol. This definition is a generalization of the examples, and is useful for recognizing other examples of the symbol.

The objects in the semantic network are geometric primitives: e.g. line and arc segments. The links in the network are geometric relationships between the primitives. These may include (among others):

The existence of intersections between primitives.

The relative location of intersections.

The angle between intersecting lines.

The existence of parallel lines.

In addition to the relationships, each primitive is characterized by (intrinsic) properties, including:

Type: line or arc.

Length.

Relative length.

We describe distance by both an absolute and relative metric. An absolute distance is measured in pixels, or other hardware dependent unit of measure. Relative distances are measured as a proportion of the total of all of the stroke lengths in the symbol. For example, the relative length of one side of a perfect square is 25%.

Using absolute distance metrics allows the program to learn definitions in which size matters, while relative distances ignore uniform scaling. For example, if the training examples are squares of different sizes, the definition will be based on relative length and thus will be suitable for recognizing squares of all sizes. If, on the other hand, all of the training examples are squares of the same size, the definition will be based on absolute distance, and only squares of that size will be recognized. In this particular case, all of the examples will also have similar relative lengths, and thus the definition will also include requirements on relative length. However, those requirements will be redundant with those on absolute length.

The locations of intersections between primitives are measured relative to the lengths of the primitives. For example, if the beginning of one line segment intersects the middle of another, the intersection is described as the point (0%, 50%). When extracting intersections from the sketch, a tolerance is used to allow for cases in which an intersection was intended, but one of the primitives was a little too short. The tolerance zone at each end of the primitive is 25% of the length of that primitive. If an intersection occurs in the tolerance zone, it is recorded as being at the end of the primitive: The relative location is described as 0% if the intersection is near the beginning of the segment, or 100% if it is near the end.

If a pair of lines do not intersect, the program checks if they are parallel. Here again, a tolerance is used because of the imprecise nature of a sketch. Two lines are considered to be parallel if their slopes differ by no more than, for example, 5°.

To construct the definition of a symbol, the semantic networks for each of the symbols are compared to identify common attributes. If a binary attribute, such as the existence of an intersection, occurs with a frequency greater than a particular threshold, that attribute is included in the definition. Similarly, if an attribute has a continuous numerical value, such as relative length, it will be included in the definition if its standard deviation is less than some threshold.

The thresholds are empirically determined, and the values are as follows. The occurrence frequency threshold for intersections may be, for example, 70%. That is, if at least 70% of the training examples have an intersection between a particular pair of primitives, that intersection is included in the learned definition. An arc can intersect a line, or another arc, in two locations. The occurrence frequency threshold for two intersections may also be, for example, 70%. The threshold for the existence of parallelism between lines may be, for example, 50%.

The standard deviation threshold for continuous valued quantities may be, for example, 5. The maximum value for a relative length is 100, thus the standard deviation threshold would be 5% of the maximum value. Absolute length is measured in pixels and primitives can be a few hundred pixels long. Thus, the threshold for absolute length can be a little more restrictive than for relative length if large symbols are drawn. The maximum value for an intersection angle is 180 degrees. The standard deviation threshold, therefore, is about 2.8% of the largest possible intersection angle.

During training, it is assumed that the all of the examples have the same number and types of primitives. Furthermore, it is assumed that the primitives are drawn in the same order and in the same relative orientation. For example, if the four sides of a square are drawn in a clockwise loop with the end of one side connecting to the start of the next, then all examples should be drawn that way. Drawing the square by first drawing one set of parallel sides and then drawing the other set, would constitute a different drawing order. Having the end of one side connect to the end of another (rather than the start) would constitute a different relative orientation. These assumptions make it trivial to determine which primitives in one example match those of another. The advantage is that training costs are negligible.

Symbol Recognition: Matching (Construction of a Description of the Unknown Symbol and Matching the Description to Known Definitions)

After drawing a symbol, the drawer indicates that the symbol is finished by using the stylus to press a button displayed on the drawing surface (e.g., CRT or whiteboard). This begins the process of recognizing the symbol, i.e., finding the learned definition that best matches the description of the unknown symbol. After a description of the unknown symbol is constructed using the techniques described above, we may employ one of two methods for performing the recognition (matching) task. The first employs the same assumptions used during training. The symbol must have the correct number of primitives, drawn in the correct order, and with the correct relative orientation. This method is computationally inexpensive, and is therefore quite fast. The second method uses a heuristic search technique to relax many of these assumptions, although other types of search techniques (e.g. brute force) may be used. This allows for much more variation in the way a symbol is drawn, but is correspondingly more expensive. We discuss first the non-search method, as the other method is an extension of it.

For the non-search method, the order in which one draws the primitives directly indicates correspondence with the primitives in a definition. The error in the match can be directly computed by comparing the semantic networks of the unknown and the definition. This is accomplished by comparing each of the attributes and relationships included in the definition to those of the unknown. The definition that matches with the least error classifies the example. However, a maximum error can be set, such that if the best fit exceeds that maximum, the symbol is not classified (recognized).

Matching errors occur when the number and types of primitives in the unknown symbol, their properties, and their relationships differ from those of the definition. When evaluating the total error, different weights are assigned to different kinds of errors. These weights reflect our experience with which characteristics of a symbol are most important for accurately identifying a symbol.

Some of the errors are quantized, that is an error is assigned based on the number of differences, as described in Table 1. An error is assigned if the unknown symbol and definition have different numbers of primitives. The weight for this may be 0.15, that is the error is 0.15 times the absolute value of the difference. For example, if the unknown has 5 primitives, and the definition has 7, the error is 0.3. Similarly, an error is assigned if the type of a primitive in the unknown is different than that of the definition. The weight for this error may be 1.0. Likewise an error of 1.0 may be assigned for each missing intersection or parallelism between primitives.

TABLE 1
Weights assigned to quantized errors.

| Quantity | Weight |
|---|---|
| Primitive count | 0.15 |
| Primitive type | 1.0 |
| Intersection | 1.0 |
| Parallelism | 1.0 |

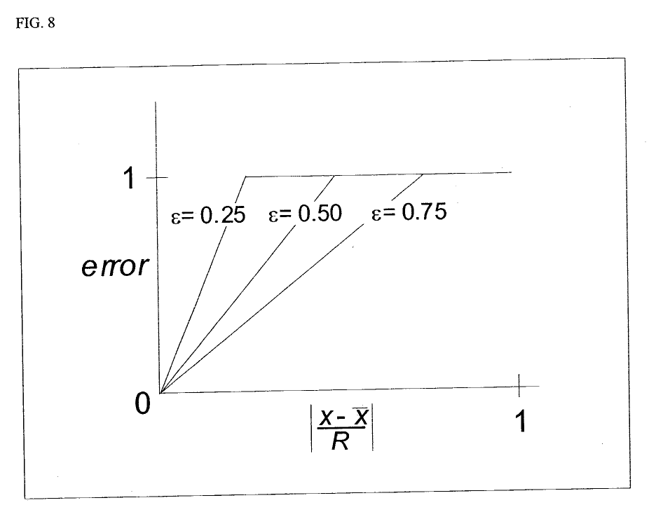

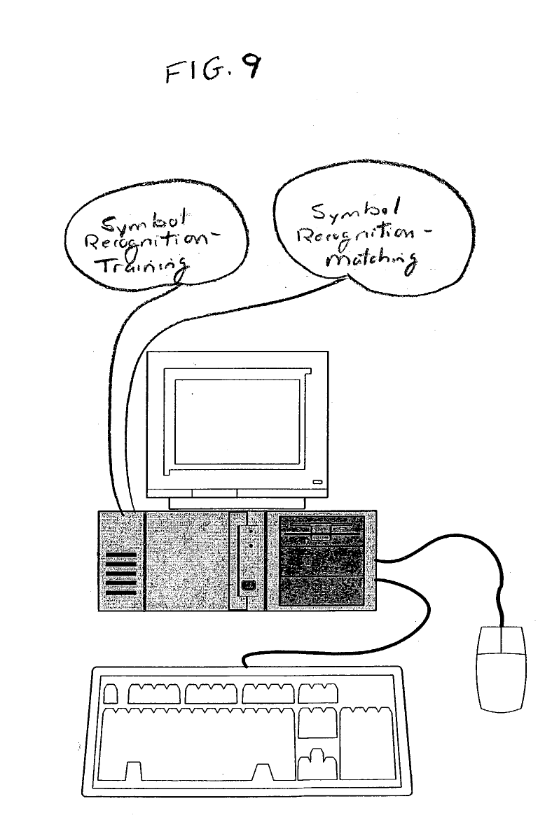

The remaining errors are assigned based on the size of the differences, rather than on the number of differences. These proportional errors are used for real valued properties such as relative length or intersection angle. Our error function is a saturating linear function:

$$e ( x ) = min \{ \begin{matrix}\vert \frac{x - \overline{x}}{∈ R} \vert \\ 1.0\end{matrix} \} \qquad ( 1 )$$

where χ is the observed value of a property, \overline{χ} is the mean value of the property observed in the training examples, ε is a tolerance, and R is the maximum expected value for the property. The error saturates at 1.0. ε determines how quickly the error saturates as shown in FIG. 8. The smaller the value of ε, the faster the function saturates. ε can be thought of as an error tolerance, because its value determines how much deviation in the property is allowed before the maximum error is assigned. Table 2 shows the error constants used for the various continuous valued properties.

Constants used for calculating the error
for continuous valued properties.

| Property | Range, R | Tolerance, ε |
|---|---|---|
| Absolute length | Ave. from training | 1.0 |
| Relative length | 100.0 | 1.0 |
| Intersection location | 100.0 | 0.33 |
| Intersection Angle | 180.0 | 0.17 |

The more primitives and properties contained in a definition, the more opportunities there are to accumulate error. It may be possible for a definition with many primitives and properties to produce a larger error than a less comprehensive definition, even if the symbol in question is a better match for the former. To avoid this, we normalize the error with the following formula:

$${E}^{′} = min \{ \begin{matrix}\frac{E}{{n}_{print} + {n}_{prop} + {n}_{ret}} + C \\ 1.0\end{matrix} \} \qquad ( 2 )$$

where E′ is the normalized error, E is the sum of all errors except the primitive count error, C is the primitive count error, nₚᵣᵢₘ is the number of primitives in the definition, and nₚᵣₒₚ is the number of properties in the definition. With this formula, the primitive count error is weighted much more heavily than the other kinds of errors. This expresses the notion that if the number of primitives in a symbol is significantly different from that of the definition, a match is unlikely.

We often find it useful to consider the accuracy of the match rather than the error. The accuracy is the complement of the error:

A=100.0(1.0−E′) (3)

An accuracy of 100 is a perfect match, while an accuracy of 0 is an extremely poor match. The unknown symbol is classified by the definition that matches with the highest accuracy. However, if that accuracy is less than about 65 or 70, the match is questionable.

Thus far, the discussion has concerned matching under the assumptions that the primitives are always drawn in the same order and in the same orientation. Now we consider a method for relaxing these assumptions to allow more variation in the way symbols are drawn. With our previous assumptions, we could rely on the drawing order to directly indicate correspondence between the primitives in the symbol and those in the definition. With our previous assumptions, the direction of the pen stroke directly indicated the relative orientation of a primitive. Here we use search to identify the relative orientations that best match the definition. Recall that relative orientation describes which end of a primitive is the start and which is the end.

Our search technique can be described as best-first search with a speculative quality metric and pruning. A search node contains a partial assignment of the primitives in the unknown symbol to those of the definition. A search node is expanded by assigning an unassigned primitive in the symbol to one in the definition. A search node is terminal if an assignment has been made for each of the primitives in the definition or if there are no remaining unassigned primitives in the unknown symbol.

The search process considers all known definitions at the same time. (It is possible to reduce computation by eliminating definitions that have significantly different properties than the unknown, such as definitions that have a significantly different number of primitives than the unknown.) The process is initialized by generating all possible assignments for the first primitive in each definition. When making the assignments, both choices of orientation are considered. As a consequence, if there are n definitions and m primitives, the search queue will initially contain 2*n*m nodes. It is possible to reduce the search space by postponing consideration of the relative orientation, but our implementation handles drawing order and relative orientation in a uniform way.

Our quality metric is the converse of the matching error. The search queue is sorted in decreasing order of the normalized matching error. The error is computed with Equation 2 except that the primitive count error is excluded. It is excluded because it would penalize most those nodes that are at the shallowest depth in the search tree. If the term were included, the search would become more like depth first search, because the nodes that had the largest number of assignments would have the lowest error, and thus would be expanded first.

For non-terminal nodes, the error in some of the properties cannot be evaluated because the associated primitives have not yet been assigned. For example, if one (or both) of a pair of intersecting lines has not been assigned, it is not possible to determine if the intersection actually exists or what the error in the location of the intersection would be if it did. In such cases, we use a speculative error estimate. If an error cannot be measured because some of the primitives have not been assigned, we assign a small default error. Currently, we assign a value of 0.05 for each such incomputable error, although other values may be used. Doing this makes sense because sketches, due to their imprecise nature, always differ to some extent from the learned definitions.

Our speculative error calculation helps to prevent poor partial assignments from being expanded further. If the initial few assignments produce a large error, and there are many properties that cannot yet be evaluated, the search node will be assigned a relatively large error value. When the queue is sorted, such nodes will effectively be eliminated from consideration. In this sense, the speculative error calculation helps the search to be efficient.

To limit the search, we set a maximum error threshold. If the error of any (non-terminal) node exceeds the threshold, it is pruned from the search. This, again, helps to make the search efficient. We typically use an error threshold of 0.2 to 0.3, although others may be used. Adjusting the threshold and the speculative error constant allow one to tune the search method. For example, by increasing the speculative error constant and decreasing the threshold, the search can be accelerated but there is an increased chance that the correct definition will not be found. Conversely, if the speculative error constant is set to zero and the threshold is made large, the search will become exhaustive, ensuring that the correct definition will always be found.

In informal tests, we have found that if the segmentation is accurate, the recognition rate is high. Our current system provides the user with the option to redraw incorrectly segmented strokes. When segmenting errors are corrected in this fashion, we achieve recognition rates of roughly 95% or better for symbols like those in FIG. 1.

We have found that often three or four training examples are adequate. Furthermore, our definitions have the ability to discriminate between similar shapes. For example, the system can distinguish between squares and non-square rectangles. Similarly it can distinguish between three lines forming a triangle and three lines forming a “U” shape.

Our search-based matching method has demonstrated that it is possible to accurately match symbols when the drawing order is varied. However, the method is expensive if there is a large number of definitions or a large number of primitives in the unknown symbol. There are simple things that can be done to make the approach more efficient. For example, the relative orientation property can be handled as a post-processing step. A default orientation can be assumed. If that results in appreciable errors in intersection locations, the orientation can be flipped.

The present invention is intended to be practiced on a computer, for example, the computer shown in FIG. 9. In the preferred embodiment, our disclosed methods of symbol recognition for both training and recognition are embodied in software and stored on the hard drive or any other type of storage device, either local or remote. The software is executed by the computer of FIG. 9 to enable the disclosed methods to be practiced.

In conclusion, we have disclosed a method that uses both pen speed and shape information to segment a pen stroke into constituent lines and arcs. We have found that pen speed gives insight into which discontinuities were intended by the drawer—it is often natural to slow the pen at such points. In addition, we use a smoothed curvature metric to detect other kinds of segment points, such as transitions between arcs of opposite curvature. We have also developed a trainable symbol recognizer that can recognize multi-stroke symbols. Typically only a few training examples are needed to learn an accurate recognizer. Our approach can distinguish between similar shapes. Furthermore, if the symbols are always drawn in the same way, i.e., the parts are always drawn in the same order, recognition and training are inexpensive.

Although the present invention has been described in conjunction with preferred embodiments thereof, those of ordinary skill in the art will recognize that many modifications and variations are possible. The present invention is not to be limited by the preceding description but only by the following claims.

What is claimed is:

1. A method of analyzing a symbol comprised of one or more drawn strokes, comprising:
calculating the speed of drawing along each stroke;
calculating a curvature metric along each stroke;
identifying the segment points within said stroke using said calculated speed and curvature;
classifying each segment between segment points as a type of primitive; and
constructing a description of the symbol using the primitives and relationships between said primitives.

2. The method of claim 1 wherein said identifying includes using a least squares best fit.

3. The method of claim 1 wherein said constructing includes constructing a description based on geometric relationships between the primitives selected from a group comprising the existence of intersections, the relative location of intersections, the angle between intersections and the existence of parallel lines.

4. The method of claim 3 wherein said description additionally includes an intrinsic property selected from the group comprising primitive type, length, and relative length.

5. The method of claim 1 wherein said method is performed as part of a training phase.

6. The method of claim 1 wherein said method is performed as part of a recognition phase.

7. A method of recognizing an unknown symbol comprised of one or more drawn strokes, comprising:
calculating speed along each stroke;
calculating a curvature metric along each stroke;
identifying the segment points within said stroke using said calculated speed and curvature;
classifying each segment between segment points as a type of primitive;
constructing a description of the unknown symbol using the primitives and relationships between said primitives; and
using said description of said unknown symbol in conjunction with a plurality of stored definitions of known symbols to select one of said known symbols as corresponding to said unknown symbol.

8. The method of claim 7 wherein said using includes comparing said description of said unknown symbol to said plurality of stored definitions.

9. The method of claim 7 wherein said using includes performing a search to select one of said plurality of stored definitions as corresponding to said unknown symbol.

10. A memory device carrying a set of instructions for performing a method of analyzing a symbol comprised of one or more drawn strokes, the method comprising:
calculating the speed of drawing along each stroke;
calculating a curvature metric along each stroke;
identifying the segment points within said stroke using said calculated speed and curvature;
classifying each segment between segment points as a type of primitive; and
constructing a description of the symbol using the primitives and relationships between said primitives.
